(19) United States
(12) Patent Application Publication
(10) Pub. No.: US 2008/0256806 A1
(43) Pub. Date: Oct. 23, 2008

(54) Cored-Out Cutlery

(75) Inventors: Christine A. Medling, Farmington, ME (US); John G. Beach, Farmington, ME (US)

Correspondence Address: BOSE MCKINNEY & EVANS LLP;2700 FIRST INDIANA PLAZA, 135 NORTH PENNSYLVANIA, INDIANAPOLIS, IN, 46204, US

(73) Assignee: Jarden Plastic Solutions, Wichita, KS (US)

(21) Appl. No.: 11/736,782

(22) Filed: Apr. 18, 2007

(51) Int. Cl. A47J 43/28

(52) U.S. Cl. 30/147; 30/345

(57) ABSTRACT

A utensil is provided comprising a body and a handle. The handle includes a plurality of openings wherein at least a first opening is adjacent a second opening.

### BACKGROUND

The present invention relates to cutlery. In particular, the present invention relates to a cutlery device or utensil used primarily for preparing, cutting, handling, serving or eating food or edible items. More particularly, the present invention relates to a handle for a cutlery device.

Due to its relatively lighter weight, low cost and disposability, plastic cutlery is very popular in more casual dining and snacking settings, such as outdoor dining, picnics, camping, indoor and outdoor sporting and recreational events, concerts, parades, parties, fairs, festivals and the like.

For manufacturers, plastic cutlery is often inexpensive to produce and package in large quantities due at least in part to its lighter weight than cutlery made from other materials such as stainless steel. In view of these qualities, manufacturers of plastic cutlery continue to search for ways to reduce material costs while maintaining or enhancing durability of the cutlery.

Due to its popularity, low cost and easy disposability, large quantities of plastic cutlery can quickly become waste that needs to be properly disposed of. Concern for the environment has led to efforts to recycle plastic and to utilize recycled plastic in the manufacture of plastic cutlery. Recycled plastic may have different properties or characteristics than non-recycled plastic. In such instances, it may be desirable to modify aspects of the design of manufactured items when recycled plastic is used.

Environmental concerns have also led to efforts to reduce the amount of plastic used in plastic cutlery items, thereby reducing the amount of disposable plastic waste.

### SUMMARY OF THE INVENTION

The present invention is directed to one or more of the aforementioned and other concerns. In one embodiment, a utensil is provided. The utensil includes a body configured to contact edible items, and a handle coupled to the body. The handle has a first end adjacent the body and a second end spaced longitudinally from the first end. A first opening is located in the handle, a second opening is located adjacent the first opening, and the first and second openings are substantially similarly shaped. The first and second openings are oblongly shaped.

At least a portion of the body may be made of plastic. The first opening may have a first area, the second opening may have a second area and the first area may be greater than the second area. The handle may include a rib portion intermediate the first opening and second opening. The first opening may have a first inner edge and the second opening may have a second inner edge, and the rib portion may be defined at least in part by the first and second inner edges. The rib portion may extend diagonally across a width of the handle. The first and second openings may have lengths in the range of about 1.0-1.75 inches and widths in the range of about 0.25-0.75 inches.

In another embodiment, a cutlery device is provided. The cutlery device includes a handle having a length, a width, a first end, and a second end longitudinally spaced from the first end; a plurality of oblongly shaped openings defined within the handle; and an insignia disposed substantially near the first end.

At least a portion of the handle may be made of plastic. At least a portion of the handle may be made of recycled plastic. A first edge and second edge may include generally opposing curved portions. A first opening may have a length in the range of about 1.25-1.75 inches and a second opening may have a length in the range of about 1.0-1.5 inches. The openings may have a width in the range of about 0.25-0.75 inches. The defined openings may be quadrilaterally shaped.

The handle may include a rib intermediate a first opening and a second opening. The rib may have a width of about 0.5 inches. The rib may have a length of about 1.0 inches. The rib may be substantially centrally located on the handle.

In another embodiment, a handle for a plastic cutlery device is provided. The handle includes a handle body having a first end and a second end spaced longitudinally from the first end, a first opening in the handle body located nearer the first end, a second opening in the handle body located nearer the second end, and a diagonally transversely extending rib integrally formed with the handle, the rib being located between the first opening and the second opening.

Each of the openings may include a first side, a second side, a third side, and a fourth side; the first side being adjacent the second side and the fourth, and the third side being adjacent the second side and the fourth side; the first side and second side converging at a first point and the third side and fourth side converging at a second point; and the first side radially converging with the fourth side and the second side radially converging with the third side.

The first opening may be larger than the second opening. The handle body may have at least a first width at one of the first and second ends and a second width at a point between the first and second ends, and the second width may be greater than the first width.

Additional features and advantages of the invention will become apparent to those skilled in the art upon consideration of the following detailed description of illustrated embodiments exemplifying the best mode of carrying out the invention as presently perceived.

### BRIEF DESCRIPTION OF THE DRAWINGS

Aspects of the present invention are more particularly described below with references to the following figures, which illustrate exemplary embodiments of the present invention:

FIG. 1 is a perspective view of one embodiment of a cored-out cutlery item in accordance with the present invention;

FIG. 2 is a top view of the embodiment of FIG. 1, providing a detailed illustration of the handle;

FIG. 3 is a cross-sectional view of line 3-3 in FIG. 2;

FIG. 4 is a bottom view of the embodiment of FIG. 1;

FIG. 5 is a side view of the embodiment of FIG. 1;

FIG. 6 is a perspective view of another embodiment of a cored-out cutlery item in accordance with the present invention; and

FIG. 7 is a perspective view of another embodiment of a cored-out cutlery item in accordance with the present invention.

### DETAILED DESCRIPTION OF THE DRAWINGS

The present disclosure refers to a number of illustrative embodiments shown in the accompanying drawings and described herein. These embodiments have been selected to enable a person of ordinary skill in the art to practice the present invention, and are not intended to limit the present invention to the precise description and illustrations disclosed.

In accordance with the present invention, a cutlery item, utensil or tool is provided. In the illustrated embodiments, such cutlery item, utensil or tool is made from a disposable material such as plastic. In certain embodiments, at least a portion of the tool is made from recycled plastic. In other embodiments, the tool may be made from other materials including stainless steel, disposable starch-polyester, or other suitable disposable or non-disposable material.

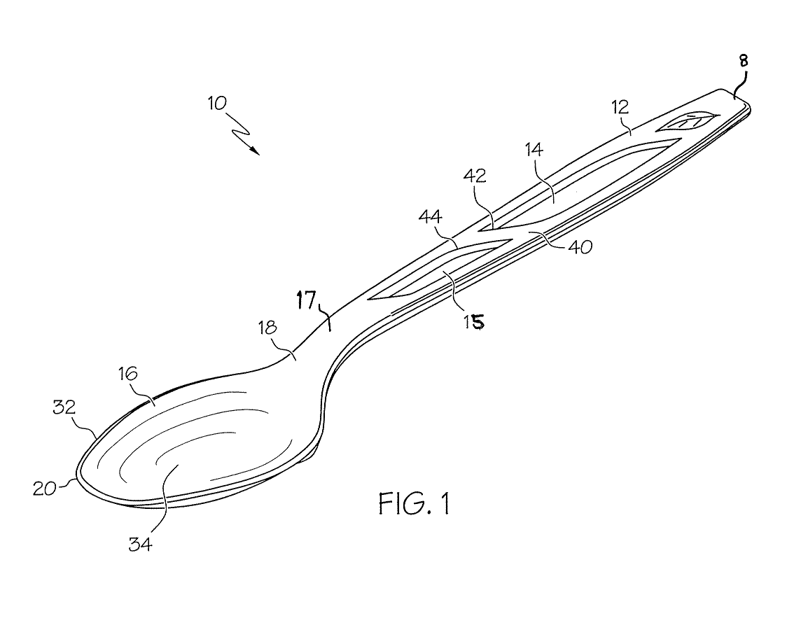

FIGS. 1-5 show an embodiment of a utensil 10 that is a spoon or spoon-like tool. The utensil 10 includes a handle 12 and a remainder or spoon portion 16.

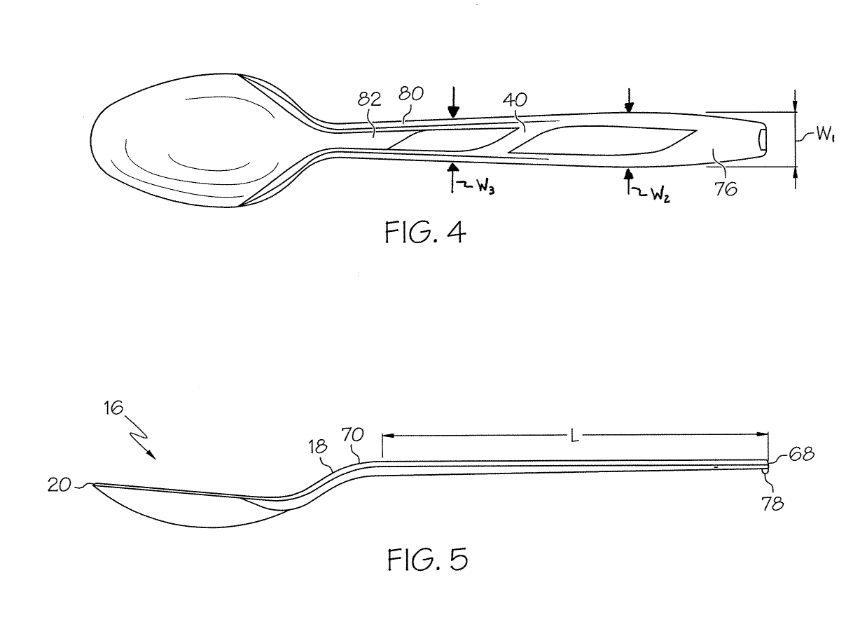

The handle 12 includes a first end 8 and a second end 17 spaced generally longitudinally from the first end. A first opening or aperture 14 and a second opening or aperture 15 are located between the first and second ends 8, 17 of the handle 12. First opening or aperture 14 is spaced from second opening or aperture 15 by a handle portion or rib 40. In the illustrated embodiment, first opening 14 is located nearer to first end 8 and second opening 15 is located nearer to second end 17 of the handle 12. Also in the illustrated embodiment, handle 12 has a width and a length, wherein the width W is less than the length L as shown in FIGS. 4-5.

First opening or aperture 14 is defined by a first inner edge 42 and second opening or aperture 15 is defined by a second inner edge 44. In the illustrated embodiment, edges 42, 44 are each formed to define a substantially oblong or elongated parallelogram-like, rhomboidal or elliptical aperture 14, 15. Also in the illustrated embodiment, edges 42 and 44 have substantially the same thickness or depth as shown.

In other embodiments, more than two openings such as openings 14, 15, may be provided. In such other embodiments, additonal ribs such as rib 40 may also be provided.

The remainder or spoon portion 16 has a first end 18 and a second end 20 spaced from the first end 18. The first end 18 is coupled to the second end 17 of the handle 12. In the illustrated embodiment, the first end 18 of the remainder portion 16 is integrally formed with the handle 12. In this embodiment, from the first end 18 to the second end 20, the remainder portion 16 consists of an outer substantially circularly or ovally shaped periphery 32 and an inner bowl or bowl-like region 34.

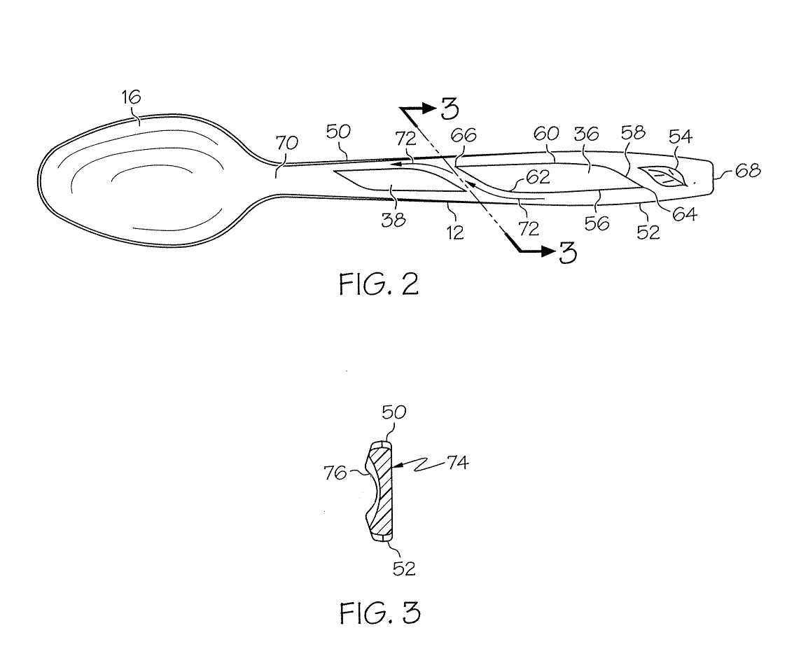

Turning to FIG. 2, first opening 14 has a first area 36 and second opening 15 has a second area 38. As shown, the first area 36 is greater than the second area 38, although the present invention should not be limited to this particular arrangement. In a different embodiment, the first area 36 could have an area similar to or less than the second area 38. The utensil 10 may weigh less and/or become easier to grasp or operate when the openings 14, 15 are greater in size. The size of the openings 14,15 may be specially sized or shaped to facilitate packaging of utensils 10. For example, openings 14,15 may be specially configured to enable a robotic arm or other mechanism to more easily pick up a utensil 10 from a production line and place the utensil 10 in a storage or packing container.

As shown in FIG. 2, the handle 12 has a first outer edge 50, and a second outer edge 52. In the illustrated embodiment, the first outer edge 50 and second outer edge 52 have substantially the same length as the handle 12. The distance between the first edge 50 and second edge 52 defines a width of the handle 12.

Additionally, the handle 12 has a first end edge 68 and a second end surface 70. The second end surface 70 of the handle 12 is adjacent to the first end 18 of the remainder portion 16. The distance between the first end edge 68 of the handle 12 and the second end 20 of the remainder portion 16 defines the entire length of the utensil 10.

According to the illustrated embodiment in FIG. 2, the first edge 50 and second edge 52 each extend at least along the length from the first end edge 68 to the second end surface 70. As shown, however, the first edge 50 and the second edge 52 are not exactly parallel; they each include opposing slightly arcuately-shaped or curved portions such that the width of the handle 12 is not exactly uniform along the entire length of the handle 12 as best shown in FIG. 4. For example, a first portion of the handle 12 has a first width W₁, at least a middle portion of the handle 12 has a second width W₂, and a third portion of the handle 12 has a third width W₃, where each of W₁, W₂ and W₃ are different widths. In the illustrated embodiment, W₂ is greater than W₁ and W₃. In other embodiments, one or more of W₁, W₂, and W₃ may be substantially the same or identical.

In the illustrated embodiment, as the first edge 50 and second edge 52 converge toward the first end 68, both edges curve radially inward. In another embodiment, the first edge 50 and second edge 52 may converge to a point such that first end 68 does not have a defined width. An insignia or label 54 is provided near the first end 68 in the illustrated embodiment. Insignia or label 54 may be formed during molding of utensil 10, by etching, applied via adhesive or by other suitable manner.

In the illustrated embodiment, the first opening 14 is adjacent to the second opening 15. In the illustrated embodiment, first opening 14 has dimensions in the range of about 1.25-1.75 inches length and about 0.5-0.75 inches in width, and second opening 15 has dimensions in the range of about 1.0-1.5 inches in length and about 0.25-0.5 inches in width. In other embodiments, the dimensions of openings 14, 15 may be larger or smaller.

A rib 40 is intermediate the first opening 14 and second opening 15. As shown in FIG. 1, the rib 40 is defined at least in part by portions of inner edges 42, 44. A portion of the first border 42 is adjacent to the first opening 14 and a portion of the second border 44 is adjacent to the second opening 15. The rib 40 has a curvature flow substantially diagonally transversely across the width of the handle 12, along direction 72 as best shown in FIG. 2. In the illustrated embodiments, rib 40 is substantially centrally located with respect to the first and second ends of the handle 12.

As shown in FIG. 2, both the first area 36 and second area 38 have a shape similar to an oblongly shaped quadrilateral. The first opening 36 includes a first side 56, a second side 58, a third side 60, and a fourth side 62. The first side 56 is adjacent to the second side 58 and fourth side 62. The third side 60 is adjacent to the second side 58 and fourth side 62. In FIG. 2, the first side 56 and second side 58 converge at a first point 64. Also, the third side 60 and fourth side 62 converge at a second point 66. As an enhancing feature to the aesthetic appearance of the handle 12, the first side 56 and fourth side 62 radially converge and the second side 58 and third side 60 radially converge. Second opening 38 has first, second, third, and fourth sides similarly to those described with reference to first opening 36.

FIG. 3 illustrates a cross-sectional view of line 3-3 in FIG. 2. In FIG. 3, the top surface 74 and first edge 50 and second edge 52 are shown. The bottom surface 76 has a concavely shaped middle portion as shown. First end edge 68 may be formed to include a lip or rounded portion, shown as element 78 in FIG. 5, to aid in stacking or packing of utensils 10 or for other reasons.

FIG. 4 shows the bottom surface 76 of the utensil 10 of FIG. 1. The handle 12 and part of the first end 18 of the remainder portion 16 have a raised periphery 80. The interior region 82 of the bottom surface 76 tends to be concavely shaped and curves away from the center of the interior region toward the raised periphery 80 as best shown in FIG. 3. As illustrated in FIG. 4, the handle 12 has a width as described above.

In general, the remainder portion 16 has a width greater than the handle width. Additionally, the handle width does not remain uniform from the first end 68 to the second end 70.

Referring to FIG. 5, the utensil 10 is shown from the side. When the first end 68 of the handle 12 rests against a flat surface, the handle 12 slants in an upward direction from the first end 68 to the second end 70. The first end 18 of the remainder portion 16 tends to curve downwardly before curving back upwardly toward the second end 20.

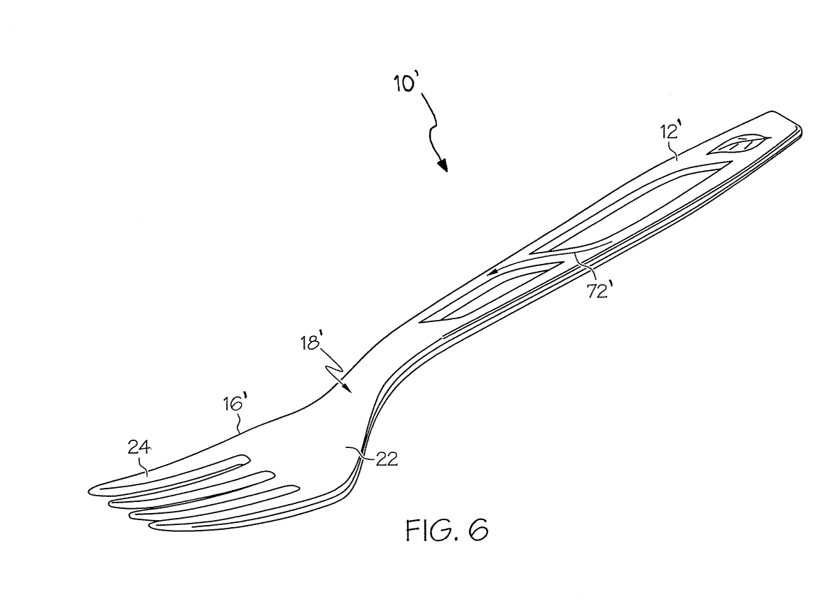

FIG. 6 shows another exemplary embodiment of a utensil 10′ in accordance with the present invention. Utensil 10′ is a fork or fork-like implement. The handle 12′ in FIG. 6 is substantially similar to the handle 12 of FIG. 1. In FIG. 6, the remainder portion 16′ includes a body 22 nearest the first end 18′. A plurality of prongs 24 extend from the body 22 in a direction away from the first end 18′ of the handle 12.

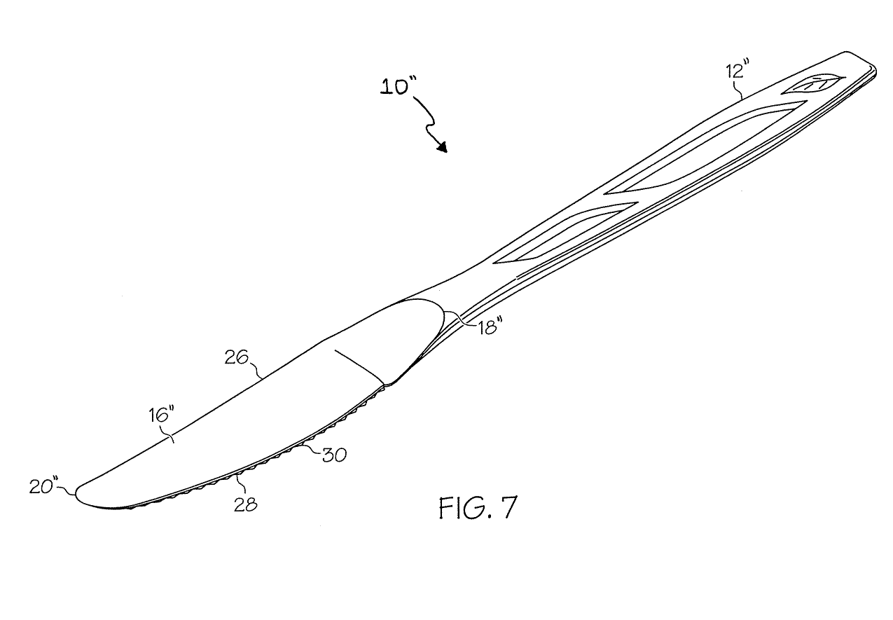

FIG. 7 illustrates a third exemplary embodiment of a cutlery item 10″ in accordance with the present invention. Item 10″ is a knife or knife-like utensil. The handle 12″ is similar to the handle 12 in FIG. 1. However, in FIG. 7, the remainder portion 16 lies substantially in the same plane as the handle 12. The remainder portion 16″ has a first edge 26 and a second edge 28. The first edge 26 and second edge 28 extend the length of the remainder portion 16″. The first edge 26 has a substantially straight and smooth surface, whereas the second edge 28 is radial from the first end 18″ of the remainder portion 16 to the second end 20″. Additionally, the second edge 28 is substantially unsmooth and includes a jagged portion 30 suitable for cutting or slicing.

Although the invention has been described in detail with reference to several embodiments, variations and modifications exist within the scope and spirit of the present invention.

What is claimed is:

1. A utensil, comprising
a body configured to contact edible items,
a handle coupled to the body, the handle having a first end adjacent the body and a second end spaced longitudinally from the first end,
a first opening located in the handle,
a second opening located adjacent the first opening, the first and second openings being substantially similarly shaped.

2. The utensil of claim 1, wherein the first and second openings are oblongly shaped.

3. The utensil of claim 1, at least a portion of the body is made of plastic.

4. The utensil of claim 3, wherein the first opening has a first area, the second opening has a second area and the first area is greater than the second area.

5. The utensil of claim 1, wherein the handle includes a rib portion intermediate the first opening and second opening.

6. The utensil of claim 5, wherein the first opening has a first inner edge and the second opening has a second inner edge, and the rib portion is defined at least in part by the first and second inner edges.

7. The utensil of claim 5, wherein the rib portion extends diagonally across a width of the handle.

8. The utensil of claim 1 wherein the first and second openings have lengths in the range of about 1.0-1.75 inches and widths in the range of about 0.25-0.75 inches.

9. A cutlery device, comprising:
a handle having a length, a width, a first end, and a second end longitudinally spaced from the first end;
a plurality of oblongly shaped openings defined within the handle; and
an insignia disposed substantially near the first end.

10. The cutlery device of claim 9, wherein at least a portion of the handle is plastic.

11. The cutlery device of claim 10, wherein at least a portion of the handle includes recycled plastic.

12. The cutlery device of claim 9, wherein a first edge and second edge are generally opposing curved portions.

13. The cutlery device of claim 9, wherein a first opening has a length in the range of about 1.25-1.75 inches and a second opening has a length in the range of about 1.0-1.5 inches.

14. The cutlery device of claim 9, wherein the openings have a width in the range of about 0.25-0.75 inches.

15. The cutlery device of claim 9, wherein the defined openings are quadrilaterally shaped.

16. The cutlery device of claim 9, wherein the handle includes a rib intermediate a first opening and a second opening.

17. The cutlery device of claim 16, wherein the rib has a width of about 0.5 inches.

18. The cutlery device of claim 16, wherein the rib has a length of about 1.0 inches.

19. The cutlery device of claim 16, wherein the rib is substantially centrally located on the handle.

20. A handle for a plastic cutlery device, comprising:
a handle body having a first end and a second end spaced longitudinally from the first end,
a first opening in the handle body located nearer the first end,
a second opening in the handle body located nearer the second end, and
a diagonally transversely extending rib integrally formed with the handle, the rib being located between the first opening and the second opening.

21. The handle of claim 20, wherein each of the openings includes:
a first side, a second side, a third side, and a fourth side;
the first side being adjacent the second side and the fourth side and the third side being adjacent the second side and the fourth side;
the first side and second side converging at a first point and the third side and fourth side converging at a second point; and
the first side radially converging with the fourth side and the second side radially converging with the third side.

22. The handle of claim 21, wherein the first opening is larger than the second opening.

23. The handle of claim 22, wherein the handle body has at least a first width at one of the first and second ends and a second width at a point between the first and second ends, and the second width is greater than the first width.
